(19) United States
(12) Patent Application Publication
(10) Pub. No.: US 2025/0360414 A1
(43) Pub. Date: Nov. 27, 2025

(54) VIRTUAL OBJECT INTERACTION METHOD AND APPARATUS, DEVICE, MEDIUM, AND PROGRAM PRODUCT

(71) Applicant: Tencent Technology (Shenzhen) Company Limited, Shenzhen (CN)

(72) Inventors: Han GAO, Shenzhen (CN); Lei Chang, Shenzhen (CN); Lei Zheng, Shenzhen (CN)

(21) Appl. No.: 19/297,914

(22) Filed: Aug. 12, 2025

Related U.S. Application Data
(63) Continuation of application No. PCT/CN2024/092787, filed on May 13, 2024.

(30) Foreign Application Priority Data
Jul. 12, 2023 (CN) 202310862620.5

(51) Int. Cl. A63F 13/58

(52) U.S. Cl. CPC A63F 13/58

(57) ABSTRACT

A virtual object interaction method is performed by a computer device. The method includes: displaying a first virtual object, a plurality of associated virtual objects, and a battle virtual object in a virtual scene; in response to receiving a selection operation on a first tactical mode by the user of the computer device, displaying a first tactical layout result corresponding to the first tactical mode; and in response to receiving an object assisting operation in a process of performing a virtual battle based on the first tactical mode, displaying an assisting battle animation in which a target associated object in the plurality of associated virtual objects stops executing the reference battle action at a first location, moves from the first location to a second location, and assists, at the second location, the first virtual object to perform a virtual battle with the battle virtual object.

### CROSS-REFERENCE TO RELATED APPLICATIONS

This application is a continuation application of PCT Patent Application No. PCT/CN2024/092787, entitled “VIRTUAL OBJECT INTERACTION METHOD AND APPARATUS, DEVICE, MEDIUM, AND PROGRAM PRODUCT” filed on May 13, 2024, which claims priority to Chinese Patent Application No. 202310862620.5, entitled “VIRTUAL OBJECT INTERACTION METHOD AND APPARATUS, DEVICE, MEDIUM, AND PROGRAM PRODUCT” filed on Jul. 12, 2023, both of which are incorporated by reference in their entirety.

### FIELD OF THE TECHNOLOGY

This application relates to the field of computer technologies, and in particular, to a virtual object interaction method and apparatus, a device, a medium, and a program product.

### BACKGROUND OF THE DISCLOSURE

With the rapid development of computer technologies and the diversification of terminals, electronic games are gradually widely used. In an electronic game, a virtual scene is usually displayed on a terminal, and a player may perform a virtual battle by controlling a virtual object in the virtual scene.

In the related art, a player may control a virtual object. The virtual object and a plurality of associated virtual objects operated by non-players (for example, non-player characters) jointly perform a virtual battle with an enemy virtual object. The plurality of associated virtual objects operated by non-players are respectively pre-configured with different battle actions, so that the plurality of associated virtual objects can execute different battle actions in a virtual battle process.

However, in the related art, the plurality of associated virtual objects perform a virtual battle only according to fixed battle actions. The plurality of associated virtual objects have poor flexibility and cannot effectively deal with a real-time battle situation. Consequently, battle cooperation between the player and the plurality of associated virtual objects is low. The player needs to continuously adjust an operation policy to adapt to a fixed behavior mode of the plurality of associated virtual objects, thereby reducing human-computer interaction efficiency and increasing overheads of computer operation resources.

### SUMMARY

Embodiments of this application provide a virtual object interaction method and apparatus, a device, a medium, and a program product, to improve battle cooperation between a player and a plurality of associated virtual objects, improve human-computer interaction efficiency, and reduce overheads of computer operation resources. The following technical solutions are adopted.

According to an aspect, a virtual object interaction method is performed by a computer device and the method includes:
displaying a first virtual object, a plurality of associated virtual objects, and a battle virtual object in a virtual scene, the first virtual object being a virtual object controlled by a user of the computer device, and the plurality of associated virtual objects being configured for cooperating with the first virtual object to perform a virtual battle with the battle virtual object;
in response to receiving a selection operation on a first tactical mode by the user of the computer device, displaying a first tactical layout result corresponding to the first tactical mode; and
in response to receiving an object assisting operation in a process of performing a virtual battle based on the first tactical mode, displaying an assisting battle animation in which a target associated object in the plurality of associated virtual objects stops executing the reference battle action at a first location, moves from the first location to a second location, and assists, at the second location, the first virtual object to perform a virtual battle with the battle virtual object.

According to another aspect, a computer device is provided. The computer device includes a processor and a memory. The memory has at least one instruction, at least one program, a code set, or an instruction set stored therein. The at least one instruction, the at least one program, the code set, or the instruction set is loaded and executed by the processor to implement the virtual object interaction method according to any one of the foregoing embodiments of this application.

According to another aspect, a non-transitory computer-readable storage medium is provided. The storage medium has at least one instruction, at least one program, a code set, or an instruction set stored therein. The at least one instruction, the at least one program, the code set, or the instruction set is loaded and executed by a processor to implement the virtual object interaction method according to any one of the foregoing embodiments of this application.

The technical solutions provided in the embodiments of this application produce at least the following beneficial effects.

In a process in which a first virtual object and a plurality of associated virtual objects perform a combined battle with a battle virtual object, if a selection operation on a first tactical mode is received, the plurality of associated virtual objects may position according to a distribution rule corresponding to the first tactical mode, and execute reference battle actions corresponding to the first tactical mode. The associated virtual objects position and act according to a tactical mode selected by a player, so that a behavior mode of an associated object can meet a current tactical requirement of the player, thereby improving cooperation between the player and a plurality of virtual objects. In addition, in a battle process, when a battle assisting operation is received, a target associated object in the plurality of associated virtual objects stops executing the reference battle action and performs location adjustment, so as to assist, at a latest location after adjustment, the first virtual object in performing a battle. To be specific, the target associated object can perform real-time adjustment according to the battle assisting operation of the player, to cooperate with a current operation policy of the player, to provide better assistance for the player, thereby further improving the cooperation between the player and the plurality of virtual objects. In addition, an associated virtual role can be adjusted in cooperation with a player operation by using a simple battle assisting operation, to avoid complex operation adjustment performed by the player on the first virtual object to apply to the associated virtual object, thereby improving human-computer interaction efficiency and reducing overheads of computer operation resources.

### BRIEF DESCRIPTION OF THE DRAWINGS

FIG. 1 is a schematic diagram of a computer system according to an exemplary embodiment of this application.

FIG. 2 is a structural block diagram of an electronic device according to an exemplary embodiment of this application.

FIG. 3 is a flowchart of a virtual object interaction method according to an exemplary embodiment of this application.

FIG. 4 is a flowchart of a virtual object interaction method according to another exemplary embodiment of this application.

FIG. 5 is a schematic diagram of tactical mode selection according to an exemplary embodiment of this application.

FIG. 6 is a schematic diagram of an isolation tactic mode according to an exemplary embodiment of this application.

FIG. 7 is a schematic diagram of a method for displaying an assisting battle animation according to an exemplary embodiment of this application.

FIG. 8 is a schematic diagram of a high-pick-and-roll tactic according to an exemplary embodiment of this application.

FIG. 9 is a schematic diagram of a doubling-post tactic according to an exemplary embodiment of this application.

FIG. 10 is a schematic diagram of a switch-everything tactic according to an exemplary embodiment of this application.

FIG. 11 is a schematic diagram of a 2-3 zone defense tactic according to an exemplary embodiment of this application.

FIG. 12 is a schematic diagram of a 2-3 zone defense tactic according to another exemplary embodiment of this application.

FIG. 13 is a flowchart of a virtual object interaction method according to still another exemplary embodiment of this application.

FIG. 14 is a block diagram of a system architecture according to an exemplary embodiment of this application.

FIG. 15 is a structural block diagram of a virtual object interaction apparatus according to an exemplary embodiment of this application.

FIG. 16 is a structural block diagram of a virtual object interaction apparatus according to another exemplary embodiment of this application.

FIG. 17 is a structural block diagram of a terminal according to an exemplary embodiment of this application.

### DESCRIPTION OF EMBODIMENTS

First, terms described in embodiments of this application are briefly introduced.

A virtual environment is a virtual environment displayed (or provided) when an application is run on a terminal. The virtual environment may be a simulation environment for the real world, or may be a semi-simulation and semi-fiction three-dimensional environment, and may further be a purely fictional three-dimensional environment. The virtual environment may be any one of a two-dimensional virtual environment, a 2.5-dimensional virtual environment, and a three-dimensional virtual environment. In the following embodiments, an example in which the virtual environment is the two-dimensional virtual environment is used for description. This is not limited.

A virtual object is a movable object in the virtual environment. The movable object may be a virtual chess piece, a virtual character, a virtual animal, and a cartoon character, such as: characters, animals, plants, oil drums, walls, stones, or the like displayed in the virtual environment. In some embodiments, the virtual object is a three-dimensional spatial model created based on a skeletal animation technology. Each virtual object has a shape and a volume in the virtual environment, and occupies a part of a space in the virtual environment.

FIG. 1 shows a structural block diagram of a computer system according to an exemplary embodiment of this application. The computer system may be implemented as a system architecture of a virtual object interaction method. The computer system includes: a terminal 110, a server 120, and a communication network 130. The terminal 110 is connected to the server 120 through the communication network 130. The communication network 130 may be a wired network or a wireless network.

A target application 111 is installed and run in the terminal 110. The target application 111 is an application supporting a two-dimensional virtual environment or a three-dimensional virtual environment. The target application 111 may be any one of a virtual reality application, a three-dimensional map application, an auto chess game, a strategy game, a puzzle game, a massive multiplayer online role-playing game (MMORPG), a third-person shooting (TPS) game, a first-person shooting (FPS) game, a multiplayer online battle arena (MOBA) game, a multilayer gunfight survival game, a sports competition game, a party casual game, a construction game, and the like. In addition, this application does not limit the form of the target application 111, which includes, but is not limited to, an application (App), an applet, a web page, etc. installed in the terminal 110. In a possible implementation, the target application 111 may be a stand-alone application, for example, a stand-alone strategy game program, or may be an online application.

In some embodiments, a first device performing a virtual object display method provided in an embodiment of this application may be implemented as the terminal 110.

In some embodiments, when the target application 111 is implemented as a stand-alone application, the terminal 110 displays a virtual scene picture. The virtual scene picture includes a first virtual object controlled by the terminal 100, and a virtual scene further includes a plurality of associated virtual objects and a battle virtual object. When receiving a selection operation on a first tactical mode, the terminal 110 obtains pre-stored first rendering data corresponding to the first tactical mode according to the selection operation, and renders the virtual scene picture according to the first rendering data, to display a first tactical layout result corresponding to the first tactical mode. The first tactical layout result includes positions of the plurality of associated virtual objects in a distribution rule of the first tactical mode, and reference battle actions corresponding to the first tactical mode are executed. In a process of performing a virtual battle based on the first tactical mode, after the terminal 110 receives an object assisting operation, second rendering data corresponding to a pre-stored object assisting animation is obtained according to the object assisting operation, and the virtual scene picture is rendered according to the second rendering data, to display an animation in which a target associated object in the plurality of associated virtual objects stops executing the reference battle action in the first tactical mode and moves from a first location to a second location, and assists, at the second location, the first virtual object and the battle virtual object in performing a virtual battle (the foregoing situation is not shown in FIG. 1).

In some embodiments, when the target application 111 is implemented as an online application, as shown in FIG. 1, the target application 111 is currently implemented as a sports competition game. The terminal 110 currently displays a virtual scene picture. The virtual scene picture includes a first virtual object controlled by a first account logged into on the terminal 110, a plurality of associated virtual objects, and a battle virtual object. The associated virtual objects are configured for cooperating with the first virtual object to perform a virtual battle with the battle virtual object. When receiving a selection operation on a first tactical mode, the terminal 110 generates a tactical layout request and sends the tactical layout request to the server 120. The tactical layout request is configured for requesting the server 120 for position and battle action layouts of the plurality of associated virtual objects.

After receiving the tactical layout request, the server 120 reads, according to the tactical layout request, first rendering data corresponding to the first tactical mode from a folder in which tactical modes are pre-stored, and feeds back the first rendering data as a tactical layout result to the terminal 110. After receiving the tactical layout result, the terminal 110 renders the virtual scene picture according to the first rendering data in the tactical layout result, to display positions of the plurality of associated virtual objects in the first tactical mode in a corresponding distribution rule, reference battle actions corresponding to the first tactical mode are respectively executed to perform a virtual battle with the battle virtual object.

In a process of performing a virtual battle based on the first tactical mode, when receiving an object assisting operation, the terminal 110 generates an object assisting request and sends the object assisting request to the server 120. The object assisting request is configured for requesting to determine a target associated object from the plurality of associated virtual objects to assist the first virtual object in performing a virtual battle.

After receiving the object assisting request, the server 120 first determines, from the plurality of associated virtual objects according to the first tactical mode, a target associated object assisting the first virtual object, generates second rendering data corresponding to an object assisting animation corresponding to the target associated object, and feeds back the second rendering data as an object assisting result to the terminal 110.

After receiving the object assisting result fed back by the server 120, the terminal 110 renders the virtual scene picture based on the second rendering data in the object assisting result, to display an animation in which the target associated object stops executing the reference battle action and moves from a first location to a second location, and assists, at the second location, the first virtual object in performing a virtual battle with the battle virtual object.

The terminal 110 may be alternative. The terminal may be a terminal device in various forms such as a desktop computer, a portable laptop computer, a mobile phone, a tablet computer, an ebook reader, a moving picture experts group audio layer III (MP3) player, a moving picture experts group audio layer IV (MP4) player, a smart television, a smart in-vehicle device, and the like. This is not limited in this embodiment of this application.

The server 120 includes at least one of one server, a plurality of servers, a cloud computing platform, and a virtualization center. In some embodiments, the server 120 takes on primary computing work, and the terminal 110 takes on secondary computing work. Alternatively, the server 120 takes on the secondary computing work, and the terminal 110 takes on the primary computing work. Alternatively, a distributed computing architecture may be used between the server 120 and the terminal 110 for collaborative computing.

The server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The cloud technology refers to a hosting technology that combines a series of resources such as hardware, software, and networks in a wide area network or a local area network to perform data calculation, storage, processing, and sharing.

In some embodiments, the server may be further implemented as a node in a blockchain system.

The information (including, but not limited to, user equipment information, user personal information, and the like), data (including, but not limited to, data for analysis, stored data, displayed data, and the like), and signals involved in this application are all authorized by the user or fully authorized by each party, and the collection, use, and processing of relevant data need to comply with relevant laws and regulations of relevant regions.

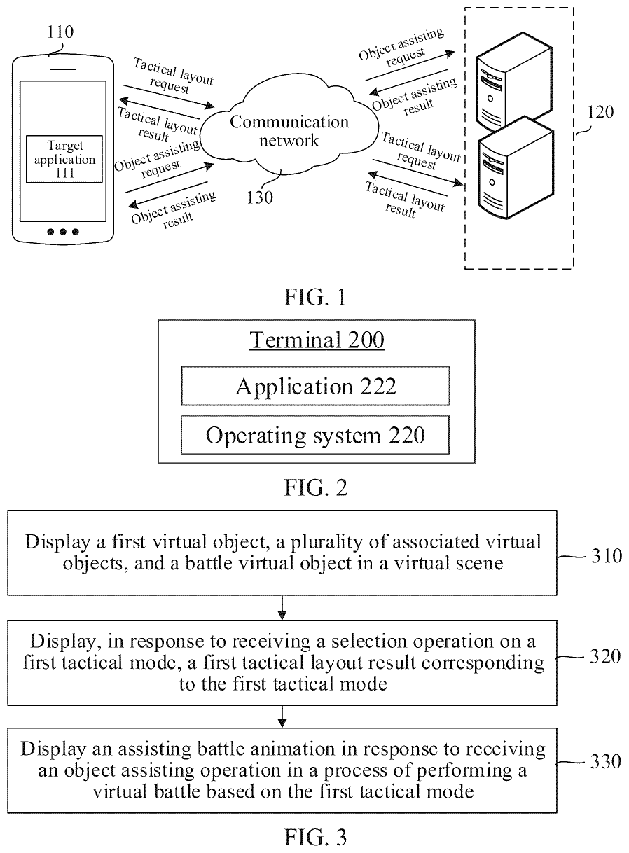

FIG. 2 is a structural block diagram of an electronic device according to an exemplary embodiment of this application. An electronic device 200 includes: an operating system 220 and an application 222.

The operating system 220 is basic software provided for the application 222 to perform secure access to computer hardware.

The application 222 is an application supporting a virtual environment. In some embodiments, the application 222 is an application that supports a three-dimensional virtual environment. The application 222 may be any one of a virtual reality application, a three-dimensional map application, a massive multiplayer online role-playing game (MMORPG), a third-person shooting (TPS) game, a first-person shooting (FPS) game, a multiplayer online battle arena (MOBA) game, a multilayer gunfight survival game, a social game, a puzzle game, a strategy game, a sports competition game, a party casual game, a construction game, and the like. In addition, this application does not limit the form of the application 222, which includes, but is not limited to, an application (App), an applet, or a web page. The application 222 may be a standalone application, such as a standalone game application, or may be a network online application.

The virtual object interaction method provided in this application is described in combination with the above introduction. The method may be performed by a server or a terminal or jointly by the server and the terminal. In this embodiment of this application, for example, the method is performed by the terminal. As shown in FIG. 3, the method includes the following operations.

Operation 310: Display a first virtual object, a plurality of associated virtual objects, and a battle virtual object in a virtual scene.

The first virtual object is a virtual object controlled by a first account logged into on a first device, and the plurality of associated virtual objects are configured for cooperating with the first virtual object to perform a virtual battle with the battle virtual object in a specified tactical mode.

Schematically, the first device may be implemented as a terminal, a target application runs in the terminal, and the target application may be implemented as any one of application types correspondingly described in FIG. 1 or FIG. 2. In a process of running the target application, the first account is logged into on the terminal.

In some embodiments, a virtual scene picture corresponding to the virtual scene is displayed in the process of running the target application by the terminal. The virtual scene picture includes, in addition to the first virtual object controlled by the first account, the plurality of associated virtual objects and the battle virtual object.

Schematically, the first account may control the first virtual object to perform at least one of operation types such as moving in the virtual scene, executing a specified action, interacting with another virtual object (including at least one of an associated virtual object or a battle virtual object), and completing a specified task. To be specific, a behavior of the first virtual object in the virtual scene is completely controlled by the first account.

Schematically, the associated virtual object is a virtual object having an association relationship with the first virtual object, for example, a teammate relationship, a subordinate relationship, or the like. When the association relationship is implemented as a teammate relationship, the associated virtual object may alternatively be referred to as a teammate virtual object of the first virtual object. When the association relationship is implemented as a subordinate relationship, the associated virtual object may alternatively be referred to as a subordinate virtual object of the first virtual object.

In some embodiments, at least one of the plurality of associated virtual objects may be controlled by the first account. Alternatively, the plurality of associated virtual objects are non-player characters (NPC). Alternatively, at least one of the plurality of associated virtual objects may be controlled by another account. This is not limited.

When the plurality of associated virtual objects are NPCs, actions of the associated virtual objects in the virtual scene are controlled by artificial intelligence (AI).

In some embodiments, action generation manners of the associated virtual objects include at least one of the following manners:

1. A plurality of action animations corresponding to an associated virtual object is preset, an execution state of the associated virtual object is marked on each action animation, and an action folder is generated. When a state of the associated virtual object in a virtual scene conforms to a specified execution state in the action folder, an action animation corresponding to the specified execution state is read and played.

2. An action behavior tree corresponding to the associated virtual object is generated, where the action behavior tree includes a plurality of action branches of the associated virtual object, and each action branch is marked with an execution condition. When the state of the associated virtual object in the virtual scene satisfies the execution condition in the action behavior tree, the action branch corresponding to the execution condition is read, and an action corresponding to the action branch is executed.

3. A whole set of action sets is preset for each associated virtual object. The action set includes a plurality of actions arranged in a sequence, and the associated virtual object sequentially executes the plurality of actions in the action set during an activity process in the virtual scene.

4. An action model is trained in advance, a real-time state of the associated virtual object in the virtual scene is inputted to the action model, and an action matching the real-time state is outputted, so that the associated virtual object executes the action.

The foregoing action generation manners of the associated virtual objects are merely schematic examples. This is not limited in this embodiment of this application.

Schematically, the virtual scene includes at least one battle virtual object for performing a virtual battle with the first virtual object and the associated virtual objects. In one example, when the virtual scene includes a plurality of battle virtual objects, a quantity of battle virtual objects is the same as a quantity of the first virtual object and the associated virtual objects. For example, the quantity of the battle virtual objects is 5, and a sum of quantities of the first virtual object and the associated virtual objects is 5.

In some embodiments, if the target application is implemented as a sports competition application, the virtual battle includes at least one of a football battle, a basketball battle, a volleyball battle, and the like. This is not limited in this embodiment of this application. Descriptions are provided below mainly by using an example in which the target application is implemented as a basketball competition application and the virtual battle is implemented as a basketball battle.

In some embodiments, the plurality of associated virtual objects are configured for cooperating with the first virtual object to perform a virtual battle with the battle virtual object in a specified tactical mode.

The tactical mode refers to that after the plurality of associated virtual objects position according to a distribution rule, the plurality of associated virtual objects perform virtual battles at respective positions. In one example, an example in which the target application is implemented as a basketball competition application is used. The virtual scene is a virtual basketball court. A basketball battle is performed by the battle virtual object, the associated virtual objects, and the first virtual object. The plurality of associated virtual objects are teammate virtual objects of the first virtual object, and the first virtual object and the teammate virtual objects are referred to as virtual players. When the tactical mode is implemented as a 2-3 zone defense mode, the virtual basketball court includes a top zone and a base zone. Two virtual players in the top zone stand at two endpoints of a free throw line in the virtual basketball court, and two virtual players at the periphery of the base zone are located within a three-point line for defense. A virtual player in the middle of the base zone is located within the three-point line, for crashing the boards. The first virtual object may freely select, by using the first account, any position in the 2-3 zone defense mode, and the associated virtual objects cooperate with the first virtual object to position according to the 2-3 zone defense mode.

In some embodiments, in an entire virtual battle process, the associated virtual objects and the first virtual object separately perform a virtual battle with the battle virtual object by using a tactical mode. Alternatively, the first account may switch a plurality of different tactical modes, so that the associated virtual objects and the first virtual object switch a plurality of different tactical modes to perform a virtual battle with the battle virtual object.

In an implementable case, the first virtual object is implemented as a non-fixed virtual object. To be specific, the first account may select at least one associated virtual object from the plurality of associated virtual objects for control, and use the associated virtual object as the first virtual object.

Operation 320: Display, in response to receiving a selection operation on a first tactical mode, a first tactical layout result corresponding to the first tactical mode.

The first tactical layout result is configured for indicating that the plurality of associated virtual objects position in a distribution rule of the first tactical mode and execute reference battle actions corresponding to the first tactical mode.

Schematically, after the selection operation on the first tactical mode is received, the first tactical mode is used as a tactical mode used in a process of performing a virtual battle by the first virtual object, the associated virtual objects, and the battle virtual object.

In some embodiments, the selection operation on the first tactical mode includes at least one of the following manners:

1. A tactical mode list is displayed in a virtual scene picture, where the tactical mode list includes a plurality of candidate tactical modes. A trigger operation on a first tactical mode of the plurality of candidate tactical modes is received as a selection operation on the first tactical mode.

2. In a process of performing a virtual battle by the first virtual object, the associated virtual objects, and the battle virtual object, according to a current battle situation, the server automatically determines a tactical mode adapted to the current situation, and automatically displays, in the virtual scene, the tactical mode adapted to the current situation. When a determining operation on the tactical mode is received, the tactical mode is determined as a first tactical mode, and the determining operation is used as a selection operation on the first tactical mode.

3. In a process of performing a virtual battle by the first virtual object, the associated virtual objects, and the battle virtual object, according to a current battle situation, the server automatically determines a plurality of candidate tactical modes adapted to the current situation, and displays a tactical mode list in the virtual scene picture, where the tactical mode list includes the plurality of candidate tactical modes automatically determined by the server. A trigger operation on a first tactical mode of the plurality of candidate tactical modes is received as a selection operation on the first tactical mode.

The foregoing selection operation manners for the first tactical mode are merely schematic examples. This is not limited in this embodiment of this application.

Schematically, different tactical modes correspond to different distribution rules. To be specific, for different tactical modes, positioning situations of the associated virtual object and the first virtual object are also different. Positions are locations of virtual objects (including the first virtual object and the associated virtual object) in the virtual scene.

Because in a virtual battle process, the first virtual object/the associated virtual object moves in the virtual scene, the position may be implemented as a zone range in which the first virtual object/the associated virtual object moves in the virtual scene. For different tactical modes, the range in which the first virtual object/the associated virtual object moves is different. For example, for a basketball competition application, when tactical mode a is implemented, the associated virtual object moves within a three-point line. When tactical mode b is implemented, the associated virtual object moves within a free throw line.

Schematically, different tactical modes correspond to different battle actions. For example, for a defense tactical mode, the battle action corresponding to the first virtual object/the associated virtual object includes at least one of action types such as defense, steal, and block. For an offense tactical mode, the battle action corresponding to the first virtual object/the associated virtual object includes at least one of action types such as pass, post up, dribble drive, and shoot. Therefore, the battle action corresponding to the tactical mode is referred to as a reference battle action. The battle action corresponding to the tactical mode is a preset action.

In some embodiments, different tactical modes not only include different distribution rules, but also include different types of battle actions.

Schematically, for a same tactical mode, a position has a correspondence with the reference battle action. For example, a virtual object positioning within a three-point line executes a dribble action, and a virtual object positioning within a free throw line executes a dunk action. In another example, for a same tactical mode, a position may not have a correspondence with the reference battle action. For example, a virtual object at location a may randomly execute at least one of reference battle action A, reference battle action B, and reference battle action C.

In some embodiments, for a same tactical mode, a single position corresponds to a single reference battle action, or a single position corresponds to a plurality of different reference battle actions. For example, a virtual object positioning within a free throw line may execute a dunk action, a jump action, and the like.

The reference battle action involved in this application is a battle action corresponding to a tactical mode in a design process, and the reference battle action is for a single associated virtual object. To be specific, reference battle actions respectively corresponding to a plurality of associated virtual objects may be the same or may be different.

In an implementable case, when the first tactical mode is selected for performing a virtual battle, the first virtual object and the plurality of associated virtual objects are displayed to automatically position according to a distribution rule corresponding to the first tactical mode, and reference battle actions corresponding to the first tactical mode are executed at the respective positions to perform a virtual battle with the battle virtual object. In this case, after the first virtual object automatically positions according to the first tactical mode, the first account may control to execute an action different from the reference battle action.

In another implementable case, when the first tactical mode is selected for performing a virtual battle, the plurality of associated virtual objects are displayed to automatically position according to a distribution rule corresponding to the first tactical mode, and reference battle actions corresponding to the first tactical mode are executed at the respective positions to perform a virtual battle with the battle virtual object. In addition, the first virtual object is controlled by the first account to freely move, and is controlled by the first account to execute an action.

In some embodiments, a manner of determining positions and reference battle actions of a plurality of associated virtual objects corresponding to a tactical mode includes at least one of the following centralized determining manners:

1. According to a tactical mode, a position and a reference battle action corresponding to an associated virtual object are specified. For example, for tactical mode a, the plurality of associated virtual objects include object a, object b, and object c. Object a is specified to offend within zone 1, object b is specified to trap within zone 2, and object c is specified to defend within zone 3.

2. After the tactical mode is determined, according to real-time locations of a plurality of associated virtual objects in a current virtual scene, each associated virtual object is automatically allocated to a position closest to the real time location, and a corresponding reference battle action is executed at the location. For example, currently, object 1 is in zone a, and object 2 is in zone b. After receiving a selection operation on a first tactical mode, object 1 is moved to position A within zone a, and object 2 is moved to position B within zone b.

3. Each associated virtual object corresponds to a different offense-defense capability, and each position in the tactical mode corresponds to an offense-defense condition. After the tactical mode is determined, according to a degree of matching between the offense-defense capability of the associated virtual object and the offense-defense condition, the associated virtual object is allocated to a position best matching the offense-defense capability of the associated virtual object. For example, object c is good at defense, and position a in tactical mode A is configured for defense. Therefore, object c is allocated to position a to execute a defense action.

The foregoing manners of determining positions and reference battle actions of a plurality of associated virtual objects are merely schematic examples. This is not limited in this embodiment of this application.

Operation 330: Display an assisting battle animation in response to receiving an object assisting operation in a process of performing a virtual battle based on the first tactical mode.

The assisting battle animation includes an animation in which a target associated object in the plurality of associated virtual objects stops executing the reference battle action, moves from a first location to a second location, and assists, at the second location, the first virtual object to perform a virtual battle with the battle virtual object.

In some embodiments, in the process of performing a virtual battle based on the first tactical mode, the first virtual object is controlled by the first account to move and execute an action in the virtual scene, and the plurality of associated virtual objects automatically move and execute actions according to the first tactical mode.

Schematically, the object assisting operation is an operation of determining, from the plurality of associated virtual objects, at least one target associated object to execute a new action after stopping executing an initial battle action, to assist the first virtual object in performing a virtual battle with the battle virtual object.

In some embodiments, an operation manner of the object assisting operation may include at least one of the following operation types:

1. An assisting control is displayed in the virtual scene picture, and a trigger operation on the assisting control is received as an object assisting operation.

2. Object identifiers separately corresponding to the plurality of associated virtual objects are displayed in the virtual scene picture, and a trigger operation on the object identifier of the target associated object is received as an object assisting operation.

The foregoing operation manners for the object assisting operation are merely schematic examples. This is not limited in this embodiment of this application.

In the first case in the foregoing operation manner, after the trigger operation on the assisting control is received, the target associated object for assisting the first virtual object is automatically determined. Alternatively, the target associated object for assisting the first virtual object is freely selected by the first account.

Schematically, assisting the first virtual object to perform a virtual battle with the battle virtual object refers to adjusting a location and a reference battle action of the associated virtual object according to an assisting action of the object assisting operation, so that the adjusted location of the associated virtual object and the executed battle action conform to an assisting intention of the first virtual object.

In some embodiments, the object assisting operation corresponds to different assisting actions, for example, at least one of the following types: receive the pass (receive the pass from the first virtual object), pick and roll, steal, and block.

Schematically, the assisting action corresponds to the tactical mode. For example, when the tactical mode is high pick and roll, when the object assisting operation is received, the assisting action is enabling the target associated object to set a pick and roll for a ball handler. Therefore, in different tactical modes, after object assisting operations are received, corresponding assisting actions are different.

In some embodiments, a single tactical mode corresponds to one assisting action. Alternatively, a single tactical mode corresponds to a plurality of different assisting actions.

Schematically, after the object assisting operation is received, the target associated object is determined from the plurality of associated virtual objects, to display an animation in which the assisting action corresponding to the tactical mode is executed after a location of the target associated object is changed.

In some embodiments, the assisting action executed in a process in which the target associated object assists the first virtual object conforms to a tactical policy of the first tactical mode. Alternatively, the assisting action executed in a process in which the target associated object assists the first virtual object does not conform to the tactical policy of the first tactical mode. For example, the first tactical mode is a tactical mode of trapping from both sides. However, if the target associated object receives the object assisting operation to execute a steal action, the assisting action executed in a process in which the target associated object assists the first virtual object does not conform to the tactical policy of the first tactical mode.

In some embodiments, a manner of determining a target associated object from a plurality of associated virtual objects includes at least one of the following manners:

1. Different associated virtual objects correspond to different offense-defense capabilities, different tactical modes correspond to assisting actions of different offense-defense requirements, and an associated virtual object meeting the offense-defense requirements is determined as a target associated object according to a degree of matching between the offense-defense capabilities of the associated virtual objects and the assisting and offense-defense requirements.

2. According to a distance between the associated virtual object and the first virtual object in the virtual scene, when there is an associated virtual object for which the distance reaches a preset distance threshold, the associated virtual object is determined as a target associated object.

3. According to execution statuses of reference battle actions of the associated virtual objects in the virtual scene, including an execution starting state, an executing state, and an execution ending state, an associated virtual object in the execution ending state is used as a target associated object, thereby ensuring continuity of execution of the assisting action by the target associated object.

The foregoing manners of determining a target associated object are merely schematic examples. This is not limited in this embodiment of this application.

In conclusion, according to the virtual object interaction method provided in this embodiment of this application, in a process in which a first virtual object and a plurality of associated virtual objects perform a combined battle with a battle virtual object, if a selection operation on a first tactical mode is received, the plurality of associated virtual objects may position according to a distribution rule corresponding to the first tactical mode, and execute reference battle actions corresponding to the first tactical mode. The associated virtual objects position and move according to a tactical mode selected by a player, so that a behavior mode of an associated object can meet a current tactical requirement of the player, thereby improving cooperation between the player and a plurality of virtual objects. In addition, in a battle process, when a battle assisting operation is received, a target associated object in the plurality of associated virtual objects stops executing the reference battle action and performs location adjustment, so as to assist, at a latest location after adjustment, the first virtual object in performing a battle. To be specific, the target associated object can perform real-time adjustment according to the battle assisting operation of the player, to cooperate with a current operation policy of the player, to provide better assistance for the player, thereby further improving the cooperation between the player and the plurality of virtual objects. In addition, an associated virtual role can be adjusted in cooperation with a player operation by using a simple battle assisting operation, to avoid complex operation adjustment performed by the player on the first virtual object to apply to the associated virtual object, thereby improving human-computer interaction efficiency and reducing overheads of computer operation resources.

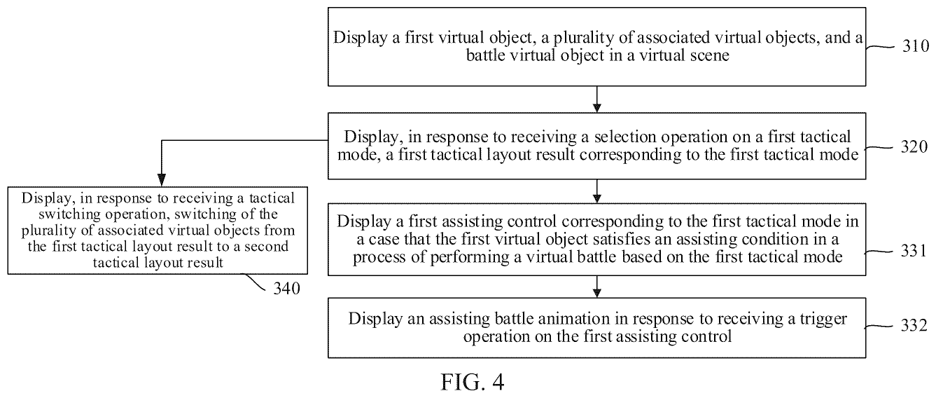

In some embodiments, a target associated object is determined according to offense-defense capabilities of associated virtual objects. Schematically, FIG. 4 shows a virtual object interaction method according to an exemplary embodiment of this application. To be specific, operation 330 further includes operation 331 and operation 332, and operation 320 is further followed by operation 340. As shown in FIG. 4, the method includes the following operations.

Operation 320: Display, in response to receiving a selection operation on a first tactical mode, a first tactical layout result corresponding to the first tactical mode.

The first tactical layout result is configured for indicating that the plurality of associated virtual objects position in a distribution rule of the first tactical mode and execute reference battle actions corresponding to the first tactical mode to perform a virtual battle with the battle virtual object.

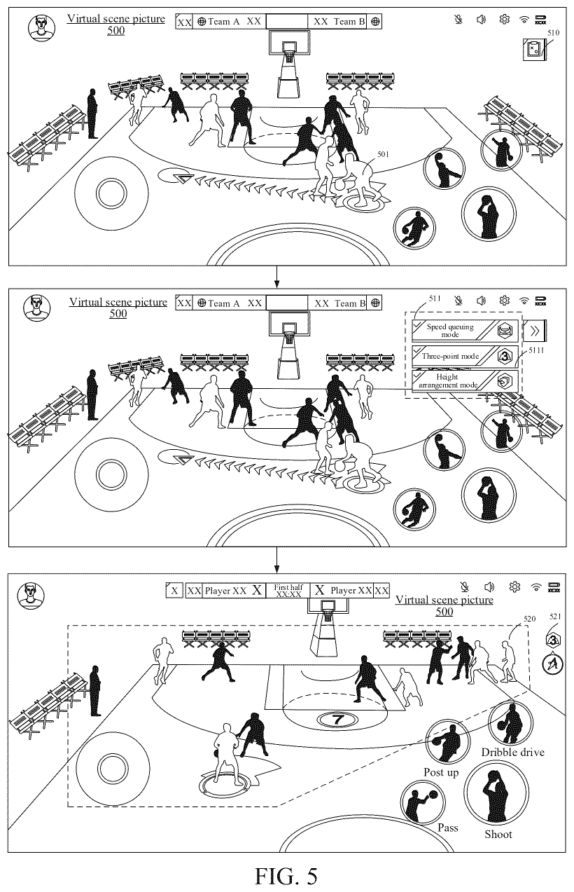

Schematically, FIG. 5 shows a schematic diagram of tactical mode selection according to an exemplary embodiment of this application. As shown in FIG. 5, a virtual scene picture 500 is currently displayed. A first virtual object 501, a plurality of associated virtual objects (white objects), and a plurality of battle virtual objects (black objects) are displayed in the virtual scene 500. A tactical selection control 510 is further displayed in the virtual scene picture 500. When a trigger operation on the tactical selection control 510 is received, a tactical mode list 511 is displayed. The tactical mode list 511 includes a plurality of candidate tactical modes. When a trigger operation on the first tactical mode 5111 is received, a first tactical layout result 520 corresponding to the first tactical mode 5111 is displayed, and displaying of the tactical selection control 510 is switched to displaying of a first tactical mode identifier 521.

Operation 331: Display a first assisting control corresponding to the first tactical mode when the first virtual object satisfies an assisting condition in a process of performing a virtual battle based on the first tactical mode.

Schematically, the assisting condition is a condition under which a current associated virtual object can assist the first virtual object in performing a virtual battle.

In some embodiments, the assisting condition includes at least one of the following condition types:

1. A battle duration of the virtual battle reaches a preset duration threshold.

2. In a process in which the first virtual object and the associated virtual object perform a virtual battle with the battle virtual object, a difference between battle scores of the two parties reaches a preset score difference threshold.

3. An attribute value of the first virtual object reaches a preset attribute value threshold.

4. In a virtual battle process, the first account controls the first virtual object to complete a specified task.

5. The first virtual object and the associated virtual object start to perform a virtual battle with the battle virtual object.

The foregoing types for the assisting condition are merely schematic examples. This is not limited in this embodiment of this application.

In some embodiments, the first assisting control corresponds to the first assisting action. To be specific, different tactical modes correspond to different types of assisting controls. Schematically, the first assisting action corresponding to the first assisting control is a battle action executed after a target associated object is determined from the plurality of associated virtual objects, so that the target associated object is configured for assisting the first virtual object in performing a virtual battle.

In some embodiments, the first assisting action corresponds to a first offense-defense requirement. To be specific, different assisting actions correspond to different assisting requirements. For example, when the assisting action is a three-point shot, the assisting requirement is that shooting accuracy of the associated virtual object reaches 75%. The shooting accuracy of the associated virtual object is a preset object attribute. Alternatively, the shooting accuracy of the associated virtual object is obtained through statistics collection of shooting results in a historical time range.

In the following description, the target application serves as a basketball competition application. A variety of different tactical modes are described in detail.

First, according to offense-defense requirements, the tactical modes may be divided into two types of tactical modes: offense tactical modes and defense tactical modes. In the offense tactical modes, the first virtual object and the associated virtual object are ball handlers, and therefore, score against the battle virtual object. In the defense tactical modes, the battle virtual object is a ball handler, and therefore, the first virtual object and the associated virtual objects need to defend against the battle virtual object, thereby preventing the battle virtual object from scoring.

The offense tactical modes include an isolation tactic mode, a post play tactic mode, and a high-pick-and-roll tactic mode, which are described in detail below. In this application, descriptions are provided by using that the battle virtual object is an opponent and the associated virtual objects are teammates.

### 1. Isolation Tactic Mode

The isolation tactic is a tactic of spreading the floor for a ball handler among the teammates to allow the ball handler to be in a one-on-one situation with the opponent.

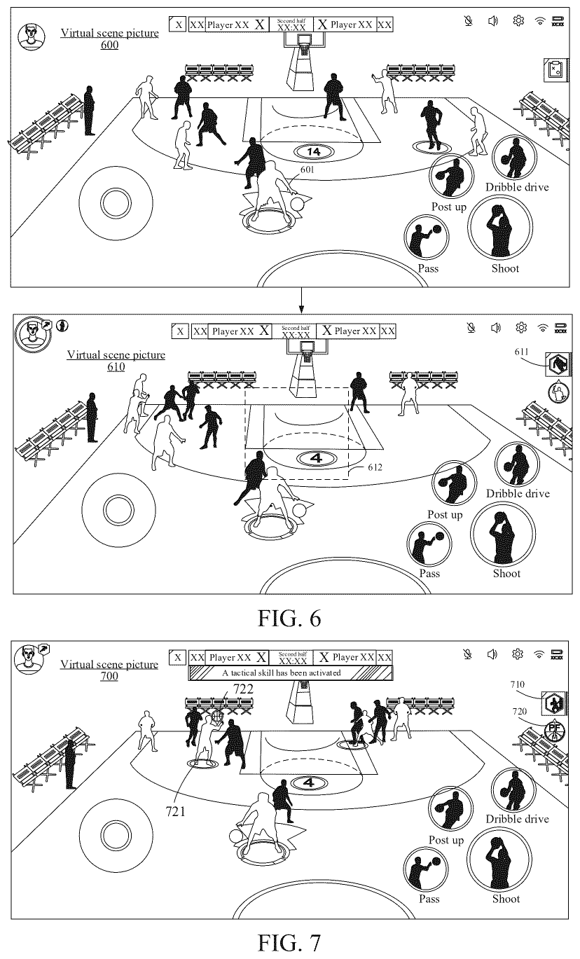

Schematically, FIG. 6 shows a schematic diagram of a tactical mode of isolation according to an exemplary embodiment of this application. As shown in FIG. 6, a virtual scene picture 600 is currently displayed. The virtual scene picture 600 includes a first virtual object 601, teammates (white), and an opponent (black). When a common offense tactic (not an isolation tactic) is performed, the teammates defending the wings have a chance to assist a ball handler in defending when the ball handler dribbles. When the isolation tactic is performed, a virtual scene picture 610 corresponding to the isolation tactic is displayed. In this case, all players other than the ball handler move toward two bottom corners of a virtual basketball court. In the virtual basketball court, more space in a top zone is reserved for the ball handler to perform an individual offense, and at the same time, a dribbling route of the ball handler is cleared, to avoid defense of the opponent. In this case, the virtual scene picture 610 corresponding to the isolation tactic includes an isolation tactic mode identifier 611 and an isolation tactic assisting space 612.

### 2. Post Play Tactic Mode

The post play tactic is a tactic in which a ball is passed to a post of a virtual basketball court or a teammate in the post makes an isolation with the opponent.

Schematically, FIG. 7 shows a schematic diagram of a method for displaying an assisting battle animation according to an exemplary embodiment of this application. As shown in FIG. 7, a virtual scene picture 700 in a post play mode is currently displayed. A post play mode identifier 710 is displayed in the virtual scene picture 700. When the first virtual object satisfies an assisting condition, a post play assisting control 720 (used as a first assisting control) is displayed below the post play mode identifier 710.

### 3. High-Pick-and-Roll Tactic Mode

The high-pick-and-roll tactic refers to calling a teammate in a post of a virtual basketball court to pick and roll for a ball handler at a high post of the court, so that the ball handler obtains an open shot.

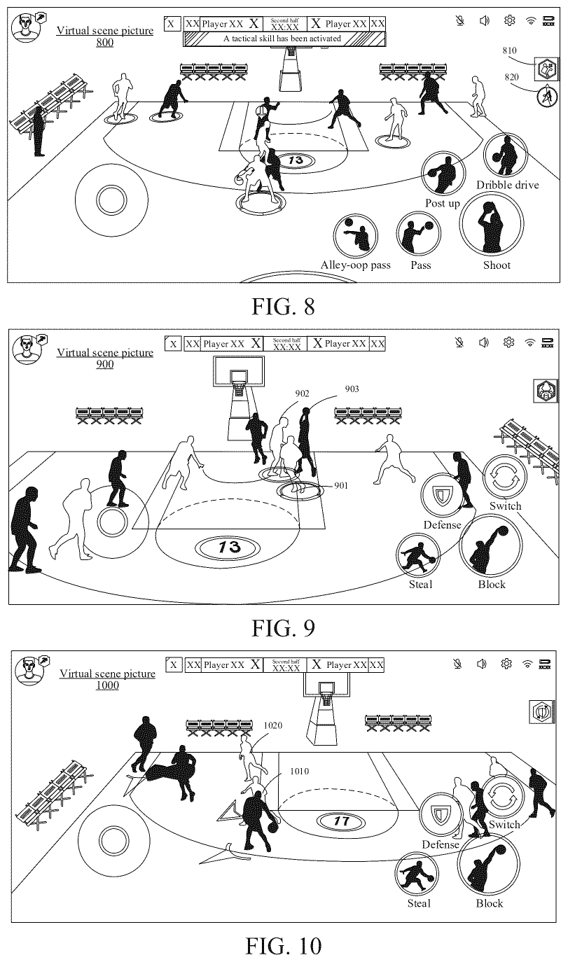

Schematically, FIG. 8 shows a schematic diagram of a high-pick-and-roll tactic according to an exemplary embodiment of this application. As shown in FIG. 8, a virtual scene picture 800 in a high-pick-and-roll tactic mode is currently displayed. The virtual scene picture 800 includes a high-pick-and-roll tactic identifier 810 corresponding to the high-pick-and-roll tactic, and a high-pick-and-roll control 820 (used as a first assisting control).

The following describes the defense tactical modes in detail. The defense tactical modes include a doubling-post tactic mode, a switch-everything tactic mode, and a 2-3 zone defense tactical mode.

### 4. Doubling Post Tactic Mode

The doubling post tactic refers to that when a ball handler (opponent) enters a post of a virtual basketball court, a defender (teammate) who defends in the post and a defender (teammate) who defends the ball handler jointly defend the ball handler, to double the post.

Schematically, FIG. 9 shows a schematic diagram of a doubling post tactic according to an exemplary embodiment of this application. As shown in FIG. 9, a doubling post tactic map 900 is currently displayed, including a first virtual object 901, an associated virtual object 902, and a battle virtual object 903. The battle virtual object 903 is a ball handler, and the associated virtual object 902 is a defender who defends in a post. When the battle virtual object 903 moves toward a basket in the post, a first account controls the first virtual object 901 to move toward the post, and the first virtual object and the associated virtual object 902 double the post for the battle virtual object 903.

### 5: Switch-Everything Tactic Mode

The switch-everything tactic refers to that when a teammate defends late, another teammate nearby will make a help defense, and at the same time, the teammate who originally defends will defend against a match-up player (opponent) corresponding to the another teammate, to form a switch tactic.

Schematically, FIG. 10 shows a schematic diagram of a switch-everything tactic according to an exemplary embodiment of this application. As shown in FIG. 10, a switch-everything tactic map 1000 is currently displayed and includes an associated virtual object 1010 and an associated virtual object 1020. The associated virtual object 1010 is originally configured for defending against a ball handler. After a defensive breakdown, the associated virtual object 1020 switches from defending against an off-ball player to defending against the ball handler, and the associated virtual object 1010 switches to defending against the off-ball player.

### 6:2-3 Zone Defense Tactic Mode

The defense refers to zone defense. A defense manner in which a player defends a zone is adopted instead of man-to-man defense.

Schematically, FIG. 11 shows a schematic diagram of a 2-3 zone defense tactic according to an exemplary embodiment of this application. As shown in FIG. 11, a 2-3 zone defense tactic map 1100 is currently displayed and includes a top zone 1110 (zone 1 and zone 2) and a base zone 1120 (zone 3, zone 4, and zone 5). Two defending teammates are arranged in the top zone 1110, and three defending teammates are arranged in the base zone 1120.

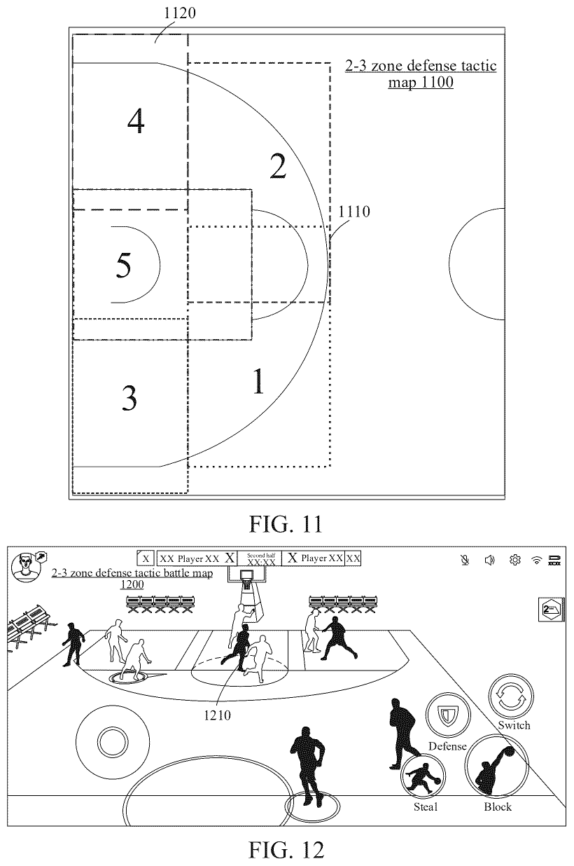

Schematically, FIG. 12 shows a schematic diagram of a 2-3 zone defense tactic battle according to an exemplary embodiment of this application. As shown in FIG. 12, a 2-3 zone defense tactic battle map 1200 is currently displayed and includes a plurality of teammates (including a first virtual object and a battle virtual object) positioning according to a 2-3 zone defense tactic. When an opponent 1210 enters a defense zone of a corresponding teammate, the teammate will defend against the opponent. When a ball handler enters an overlapping zone of two defense zones, the ball handler will be trapped by the teammates within the two defense zones.

Operation 332: Display an assisting battle animation in response to receiving a trigger operation on the first assisting control.

In an implementable case, a manner of automatically selecting the target associated object is described in detail.

In some embodiments, in response to receiving the trigger operation on the first assisting control, offense-defense capabilities separately corresponding to the plurality of associated virtual objects in the virtual scene are obtained. In response to the offense-defense capability of the target associated object satisfying the first offense-defense requirement, an animation in which the target associated object stops executing the reference battle action and moves from the first location to the second location to execute the first assisting action at the second location is displayed.

In this embodiment, descriptions will be made by using a basketball competition application. A same basketball team includes virtual objects (including associated virtual objects and a first virtual object) having different offense-defense capabilities, for example, a point guard, a shooting guard, a small forward, a power forward, and a center, separately corresponding to different offense-defense capabilities.

For a center, the center is mainly responsible for scoring at a free throw line. For a point guard, the point guard is mainly responsible for dribbling on a court.

In this embodiment, after the trigger operation on the first assisting control is received, offense-defense capabilities separately corresponding to the plurality of associated virtual objects in the virtual scene are obtained. The offense-defense capabilities of the plurality of associated virtual objects are compared with the first offense-defense requirement. When there is at least one associated virtual object satisfying the first offense-defense requirement, the associated virtual object is determined as a target associated object. For example, when the first offense-defense requirement is to perform post offense, an associated virtual object corresponding to a small forward skilled in shooting and dribbling in the post is used as a target associated object.

After the target associated object is determined, an animation in which the target associated object stops executing the current reference battle action and moves from the first location to the second location to execute the first assisting action at the second location is displayed.

As shown in FIG. 7, after a trigger operation on a post play assisting control 720 is received, a small forward is determined as a target associated object 721, and a post play identifier 722 is displayed at a specified location of the target associated object 721, to actively require after the target associated object 721 runs into a post, so that a ball handler passes the ball to the target associated object 721 for subsequent post up, shooting, and the like.

In this embodiment, an offense-defense capability of a virtual object is set, so as to be compared with a first offense-defense requirement corresponding to a first assisting control, thereby improving a degree of matching of object assisting selection, and further improving intra-team cooperation during a team battle. In addition, a target virtual object is automatically determined from a plurality of associated virtual objects according to respective corresponding offense-defense capabilities of the plurality of associated virtual objects in a virtual scene, thereby avoiding an operation of manually selecting the target virtual object, simplifying a process of displaying an assisting battle animation, and improving human-computer interaction efficiency.

In another implementable case, the target associated object is manually selected by a first account. Details are described below.

In some embodiments, an associated object list is displayed in response to receiving the trigger operation on the first assisting control, where the associated object list includes object identifiers separately corresponding to the plurality of associated virtual objects. In response to receiving a trigger operation on the object identifier corresponding to the target associated object, the assisting battle animation corresponding to the target associated object is displayed.

In this embodiment, after the trigger operation on the first assisting control is received, an associated object list is displayed in the virtual scene picture. The associated object list includes a plurality of associated virtual objects having an association relationship with the first virtual object. When the trigger operation on the object identifier of at least one associated virtual object is received, the at least one associated virtual object is determined as a target associated object, and an assisting battle animation corresponding to the target associated object is displayed.

In some embodiments, an assisting success probability corresponding to the associated virtual object is displayed at a specified location of the object identifier corresponding to the associated virtual object. The assisting success probability is a predicted probability that the associated virtual object successfully assists the first virtual object in performing a virtual battle with the battle virtual object.

Schematically, in the associated object list, in addition to displaying the object identifier corresponding to the associated virtual object, the assisting success probability of the associated virtual object is further displayed at the specified location of the object identifier of the associated virtual object. The assisting success probability is a preset probability that the associated virtual object can complete the first assisting action.

In this embodiment, by setting the associated object list, the finally selected target associated object for assisting the first virtual object better conforms to a selection intention of a player, facilitating subsequent cooperation between the player and the associated virtual object. In addition, the assisting success probability corresponding to each associated virtual object is displayed in the process of displaying the associated object list, thereby assisting the player in determining the target associated object for assisting, and increasing efficiency and accuracy of a selection operation performed by the player.

Operation 340: Display, in response to receiving a tactical switching operation, switching of the plurality of associated virtual objects from the first tactical layout result to a second tactical layout result.

The second tactical layout result corresponds to a second tactical mode, and the second tactical mode is different from the first tactical mode.

Schematically, when a trigger operation on the second tactical mode is received from the tactical mode list, the trigger operation is used as a tactical switching operation, for indicating that a current tactical mode is switched from the first tactical mode to the second tactical mode.

Because the first tactical layout result corresponding to the first tactical mode is different from the second tactical layout result corresponding to the second tactical mode, the plurality of associated virtual objects are displayed to switch from the first tactical layout result to the second tactical layout result.

In addition to that the tactical layout result is modified, after the tactical switching operation is performed, a process of switching assisting controls is further displayed. Because different tactical modes correspond to different assisting controls, the first assisting control is switched to the second assisting control.

In some embodiments, the first tactical mode corresponds to a first assisting control, and the first assisting control is configured to trigger displaying of the assisting battle animation. If the current tactical mode is switched from the first tactical mode to the second tactical mode, the first assisting control is switched and displayed to the second assisting control corresponding to the second tactical mode. The second assisting control corresponds to a second assisting action, and the second assisting action corresponds to a second offense-defense requirement.

Schematically, in response to receiving the trigger operation on the second assisting control, offense-defense capabilities separately corresponding to the plurality of associated virtual objects in the virtual scene are obtained. In response to an offense-defense capability of a first associated object in the plurality of associated virtual objects satisfying the second offense-defense requirement, an animation in which the first associated object stops executing a reference battle action corresponding to the first associated object and moves from a third location to a fourth location to execute the second assisting action is displayed.

In this embodiment, by using the tactical switching operation, based on switching of the tactical modes, the tactical layout results are also switched, so that in a process of performing a virtual battle in the virtual scene, a group battle is more flexible. In addition, by using the tactical switching operation, based on switching of the tactical modes, the assisting controls are also switched, to ensure that each tactical mode can have a corresponding assisting control, and the corresponding assisting control can better meet a requirement of a player in the mode, thereby further improving cooperation between the player and an associated virtual object. In addition, the player does not need to manually adjust a control after tactical switching, and a system automatically matches a corresponding control, so that the operation is smoother and more efficient.

In some embodiments, selection operations on the first tactical mode and a third tactical mode are continuously received, where the third tactical mode corresponds to a target battle condition. In response to a battle situation satisfying the target battle condition in the process of performing a virtual battle based on the first tactical mode, automatic switching of the plurality of associated virtual objects from the first tactical mode to the third tactical mode is displayed to perform a virtual battle with the battle virtual object.

In still another implementable case, when selection operations on the first tactical mode and the third tactical mode are continuously received from the tactical mode list, a virtual battle is first performed according to the first tactical mode. If a battle situation of a current virtual battle satisfies a target battle condition corresponding to the third tactical mode, the first tactical mode is automatically switched to the third tactical mode. For example, when a virtual battle is performed by using a post play manner, when a ball handler changes to an opponent and a teammate has a defensive breakdown, the post play manner is automatically switched to a switch-everything mode for defense.

In this embodiment, when a selection operation on at least two tactical modes is continuously received, the selected two tactical modes are automatically switched according to a battle situation of the virtual battle, thereby improving battle flexibility of a group battle, also improving human-computer interaction efficiency, and avoiding multiple manual adjustments by the player.

In conclusion, according to the virtual object interaction method provided in this embodiment of this application, an assisting control for triggering an assisting battle animation is displayed when a first virtual object satisfies an assisting condition. By setting a display restriction of the assisting control, waste of computer display resources caused by frequent clicking/tapping of the assisting control by the first virtual object is avoided.

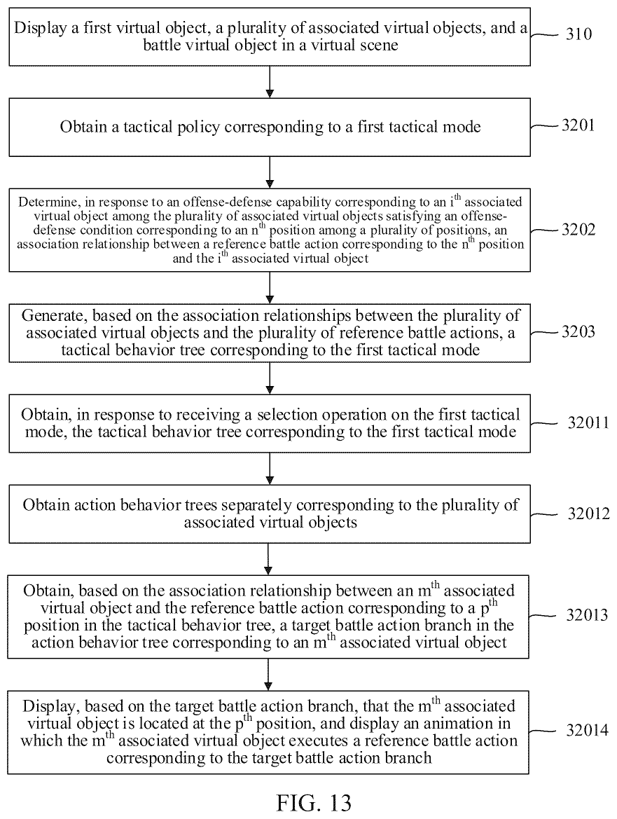

In some embodiments, an assisting battle animation is determined according to a tactical behavior tree. Schematically, FIG. 13 shows a flowchart of a virtual object interaction method according to an exemplary embodiment of this application. To be specific, operation 320 is further followed by operation 3201 to operation 3203, and operation 320 further includes operation 32011 and operation 32014. As shown in FIG. 13, the method includes the following operations.

Operation 3201: Obtain a tactical policy corresponding to a first tactical mode.

The tactical policy includes a plurality of positions and reference battle actions separately corresponding to the plurality of positions, and the plurality of positions separately correspond to offense-defense conditions.

Schematically, the tactical policy is a policy corresponding to a position layout of a virtual object and a type of a battle action executed in a process of performing a virtual battle by using a tactical mode.

Therefore, the tactical policy corresponding to the first tactical mode includes not only positions separately corresponding to the plurality of associated virtual objects, but also at least one reference battle action needing to be executed by the associated virtual objects at the positions.

In some embodiments, the offense-defense condition is a type of a battle action executed on the associated virtual object at the position in the current tactical mode. For example, an offense-defense condition of an associated virtual object at position a defends in a post. Therefore, the associated virtual object needs to move in the post and defend against an opponent.

In some embodiments, the plurality of associated virtual objects separately correspond to different offense-defense capabilities.

In this embodiment, a same basketball team includes virtual objects (including associated virtual objects and a first virtual object) having different offense-defense capabilities, for example, a point guard, a shooting guard, a small forward, a power forward, and a center, separately corresponding to different offense-defense capabilities.

In some embodiments, action behavior trees separately corresponding to the plurality of associated virtual objects are obtained. The action behavior tree corresponding to the associated virtual object includes a plurality of battle action branches of the associated virtual object in a virtual battle process, and the plurality of battle action branches are marked with different weight values. According to an action type corresponding to the battle action branch having the highest weight value among the plurality of battle action branches, the offense-defense capability corresponding to the associated virtual object is determined.

Schematically, an independent action behavior tree is set for each associated virtual object, to implement that the associated virtual object performs a virtual battle in the virtual scene. The battle action branch included in the action behavior tree corresponds to a battle action executed by the associated virtual object in the process of performing a virtual battle in the virtual scene.

In this embodiment, in the design of the action behavior tree corresponding to each associated virtual object, for different associated virtual objects, weight values corresponding to the battle action branches in the action behavior tree are also different. For example, for a power forward, the power forward has a higher ball stealing capability. Therefore, a weight value of a steal action branch is higher than a weight value of a pass action branch. An offense-defense capability corresponding to each associated virtual object is determined according to an action type corresponding to the battle action branch having the highest weight value. For example, if the action type is “shoot”, it may be determined that the offense-defense capability is a shooting guard.

In the foregoing embodiment, the offense-defense capability corresponding to the associated virtual object is determined according to the weight value corresponding to each battle action branch, to ensure that the associated virtual object has a relatively high success probability when executing a battle action with a high weight value, conforming to the corresponding offense-defense capability, thereby ensuring the proper design of the virtual object.

Operation 3202: Determine, in response to an offense-defense capability corresponding to an i^{th} associated virtual object among the plurality of associated virtual objects satisfying an offense-defense condition corresponding to an n^{th} position among the plurality of positions, an association relationship between a reference battle action corresponding to the n^{th} position and the i^{th} associated virtual object.

i and n are positive integers.

Schematically, in a process of designing a tactical mode, for a first tactical mode, a plurality of positions are set, and each position corresponds to at least one reference battle action. Therefore, each position corresponds to an associated virtual object according to offense-defense capabilities respectively corresponding to the plurality of associated virtual objects, to determine the first tactical layout result of the plurality of associated virtual objects according to the first tactical mode. Positions and associated virtual objects having association relationships are determined according to a matching relationship between the offense-defense capabilities of the associated virtual objects and offense-defense conditions corresponding to the positions.

Operation 3203: Generate, based on the association relationships between the plurality of associated virtual objects and the plurality of reference battle actions, a tactical behavior tree corresponding to the first tactical mode.

Schematically, when an association relationship between each position and the associated virtual object in the first tactical mode is determined, the tactical behavior tree corresponding to the first tactical mode is generated based on the reference battle action corresponding to the position and the association relationship between each position and the associated virtual object.

In some embodiments, different tactical modes correspond to different tactical behavior trees.

A same tactical behavior tree includes association relationships between a plurality of positions and different associated virtual objects.

Operation 32011: Obtain, in response to receiving a selection operation on the first tactical mode, the tactical behavior tree corresponding to the first tactical mode.

The tactical behavior tree includes association relationships between a plurality of associated virtual objects and a plurality of reference battle actions.

Schematically, after the tactical behavior trees respectively corresponding to the plurality of different tactical modes are preset, the tactical behavior trees respectively corresponding to the plurality of different tactical modes are stored in a specified storage file.

When a selection operation on the first tactical mode is received, the tactical behavior tree corresponding to the first tactical mode is read from the specified storage file according to the selection operation.

Operation 32012: Obtain action behavior trees separately corresponding to the plurality of associated virtual objects.

The action behavior tree corresponding to the associated virtual object includes a plurality of battle action branches of the associated virtual object in a virtual battle process.

After reading the tactical behavior tree corresponding to the first tactical mode, an action behavior tree corresponding to each associated virtual object in a preset virtual scene is obtained.

Operation 32013: Obtain, based on the association relationship between an m^{th} associated virtual object and the reference battle action corresponding to a p^{th} position in the tactical behavior tree, a target battle action branch in the action behavior tree corresponding to an m^{th} associated virtual object.

The target battle action branch corresponds to the reference battle action corresponding to the p^{th} position, where m and p are positive integers.

Schematically, after the tactical behavior tree corresponding to the first tactical mode is obtained and the action behavior trees respectively corresponding to the plurality of associated virtual objects are obtained, the reference battle action corresponding to the p^{th} position having the association relationship with the m^{th} associated virtual object is first determined according to the association relationship between the position in the tactical behavior tree and the associated virtual object, and the target battle action branch corresponding to the reference battle action in the action behavior tree corresponding to the m^{th} associated virtual object is further determined according to the reference battle action.

Operation 32014: Display, based on the target battle action branch, that the m^{th} associated virtual object is located at the p^{th} position, and display an animation in which the m^{th} associated virtual object executes a battle action corresponding to the target battle action branch.

Schematically, after the reference battle action executed by the m^{th} associated virtual object in the first tactical mode is determined according to the tactical behavior tree, an animation in which the m^{th} associated virtual object is located at the p^{th} position and a battle action corresponding to the target battle action branch is executed is displayed according to the target battle branch.

In conclusion, according to the virtual object interaction method provided in this embodiment of this application, a tactical behavior tree is generated according to a tactical policy corresponding to a tactical mode and an offense-defense capability of each associated virtual object, so that actions executed by associated virtual objects in a same team have coordination. Coordinated action execution can ensure that the virtual objects cooperate in a battle, to avoid resource waste and conflict. In addition, each virtual object can exert a maximum offense-defense capability according to an overall tactical policy, thereby improving the battle efficiency of the entire team. In addition, when the tactical policy or environment changes, because the behavior tree is generated according to the offense-defense capability of each virtual object, an action of each virtual object may be quickly adjusted to adapt to a new tactical requirement. Such flexibility enables a team to deal with various complex and variable situations, thereby improving a success rate of a battle.

In this embodiment, after a selection operation on the tactical mode is received, displaying a tactical layout result with reference to the tactical behavior tree and an action behavior tree can ensure action smoothness of each associated virtual object, and improve properness of animation display. In addition, smooth actions and proper animation display can improve immersion and satisfaction of a player, thereby enhancing overall game experience. In addition, the action behavior tree can make animation representation more accurate and proper, thereby avoiding unnecessary jumping or frame freezing, and improving animation display quality.

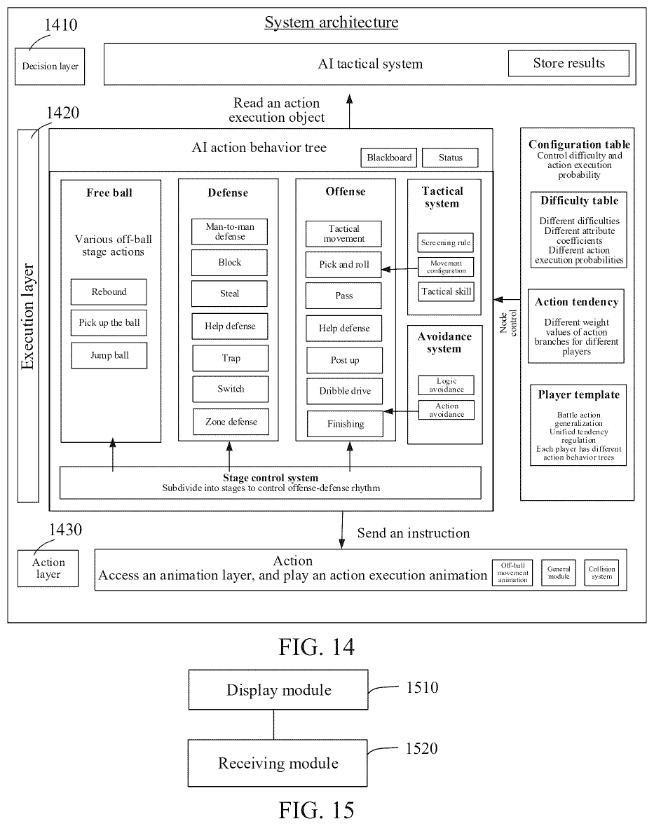

Schematically, a system architecture of a virtual object interaction method is described by applying the method to, for example, a basketball competition application. Schematically, FIG. 14 shows a block diagram of a system architecture according to an exemplary embodiment of this application. As shown in FIG. 14, the architecture includes the following content.

The system architecture is divided into three layers: a decision layer 1410, an execution layer 1420, and an action layer 1430. The layers have the following respective functions.

The decision layer 1410 makes a decision implemented by an AI tactical system. The AI tactical system is an independent tactical behavior tree system, stores tactical behavior trees respectively corresponding to a plurality of different tactical modes, and determines, according to a battle situation in a virtual scene, execution objects corresponding to various battle actions for storage.

The execution layer 1420 includes execution logic of various battle actions of a plurality of associated virtual objects in a virtual battle process, where a plurality of systems and modules are embedded therein.

An AI action behavior tree is the most important system of the execution layer 1420, and all execution logic is sent by the action behavior tree. The action behavior trees of the associated virtual objects are independent of each other. When an action behavior tree detects that a current associated virtual object is an execution object corresponding to a battle action, logic of a corresponding battle action branch is executed, to execute different battle actions, including free ball, defense, offense, and the like.

The tactical system is jointly formed by a movement editor and a screening system, and can configure a collaborative movement of off-ball offense players, thereby making it possible to implement a tactical movement. The movement editor can configure a movement and a battle action of a virtual object in a form of a timeline. The screening system screens a movement file, detects a battle status of a player, and outputs a target file according to an actual location of the player on the court. The target file is a movement file corresponding to a current battle status of the player, and after the movement file is obtained from the action behavior tree, a corresponding movement action is executed.

An avoidance system includes a logic avoidance and an action avoidance. A definition of the avoidance is: when there are other teammates around the player, or there is a ball handler near a target point, an avoidance space needs to be reserved for the teammates. The logic avoidance is: by means of calculation, an appropriate target location is selected and inputted into the action behavior tree, so that the action behavior tree drives the virtual object to execute a movement, and to finally arrive at the target location. The action avoidance is: an avoidance animation displayed after an associated virtual object collides with another player during a movement process.

A configuration table controls a battle behavior of an associated virtual object by using a difficulty table, a behavior tendency table, and a template table, thereby implementing AI difficulty control, a player personalized behavior, and a templated behavior. Probability control is performed in the behavior tree by using a matched behavior tree node. The difficulty table includes a difficulty corresponding to each battle action. The behavior tendency table is configured for indicating a target battle action (to be specific, a probability of executing a target battle action is relatively large) to which each associated virtual object tends.

The action layer 1430 receives an instruction sent by the action behavior tree, and then displays an action execution animation by using general module logic, action execution logic, and off-ball movement logic. An off-ball movement animation system implements movement animations of different speeds, different angles, and different directions, especially start and end of motion and joint, so that the player moves more truthfully and smoothly. The general module is a general module of basic behaviors such as shooting and dribbling. A corresponding instruction is inputted by using the action behavior tree, and a battle action matching the instruction is selected therefrom. In a collision system, when a player collides with another player at different behaviors, the player enters different collision animations with the opponent.

This application is a tactical implementation solution based on a behavior tree. By means of preset tactical layout data, a tactical selection control and an assisting control are added to a game, and a control relationship between tactics is designed, to provide playing experience with a combination of an operation skill and a policy decision for a player.

FIG. 15 is a structural block diagram of a virtual object interaction apparatus according to an exemplary embodiment of this application. As shown in FIG. 15, the apparatus includes the following parts:
a display module 1510, configured to display a first virtual object, a plurality of associated virtual objects, and a battle virtual object in a virtual scene, where the first virtual object is a virtual object controlled by a first account logged into on a first device, and the plurality of associated virtual objects are configured for cooperating with the first virtual object to perform a virtual battle with the battle virtual object; and
a receiving module 1520, configured to receive a selection operation on a first tactical mode.

The display module is further configured to display, in response to the selection operation, a first tactical layout result corresponding to the first tactical mode, where the first tactical layout result is configured for indicating that the plurality of associated virtual objects position in a distribution rule of the first tactical mode and execute reference battle actions corresponding to the first tactical mode.

The receiving module is further configured to receive an object assisting operation in a process of performing a virtual battle based on the first tactical mode.

The display module is further configured to display an assisting battle animation in response to the object assisting operation, where the assisting battle animation includes an animation in which a target associated object in the plurality of associated virtual objects stops executing the reference battle action, moves from a first location to a second location, and assists, at the second location, the first virtual object to perform a virtual battle with the battle virtual object.

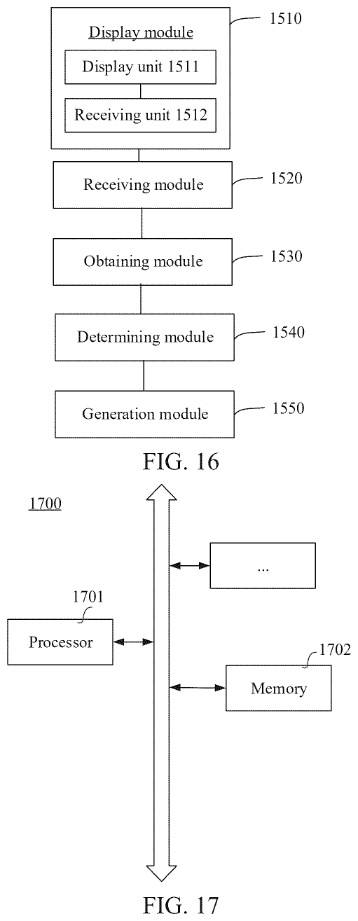

In some embodiments, as shown in FIG. 16, the display module 1510 includes:
a display unit 1511, configured to display a first assisting control corresponding to the first tactical mode when the first virtual object satisfies an assisting condition in the process of performing a virtual battle based on the first tactical mode; and
a receiving unit 1512, configured to receive a trigger operation on the first assisting control.

The display unit 1511 is further configured to display the assisting battle animation in response to the trigger operation on the first assisting control.

In some embodiments, the first assisting control corresponds to a first assisting action, and the first assisting action corresponds to a first offense-defense requirement. The receiving unit 1512 is further configured to receive a trigger operation on the first assisting control. The display unit 1511 is further configured to: obtain, in response to the trigger operation on the first assisting control, offense-defense capabilities separately corresponding to the plurality of associated virtual objects in the virtual scene; and display, in response to the offense-defense capability of the target associated object satisfying the first offense-defense requirement, an animation in which the target associated object stops executing the reference battle action and moves from the first location to the second location to execute the first assisting action.

In some embodiments, the receiving unit 1512 is further configured to receive a trigger operation on the first assisting control. The display unit 1511 is further configured to display an associated object list in response to the trigger operation on the first assisting control, where the associated object list includes object identifiers separately corresponding to the plurality of associated virtual objects. The receiving unit 1512 is further configured to receive a trigger operation on the object identifier corresponding to the target associated object. The display unit 1511 is further configured to display, in response to the trigger operation on the object identifier corresponding to the target associated object, the assisting battle animation corresponding to the target associated object.

In some embodiments, the display unit 1511 is further configured to display, at the first location of the object identifier corresponding to the associated virtual object, an assisting success probability corresponding to the associated virtual object, where the assisting success probability is a predicted probability that the associated virtual object successfully assists the first virtual object in performing a virtual battle with the battle virtual object.

In some embodiments, the receiving unit 1512 is further configured to receive a tactical switching operation. The display unit 1511 is further configured to display, in response to the tactical switching operation, switching of the plurality of associated virtual objects from the first tactical layout result to a second tactical layout result, where the second tactical layout result corresponds to a second tactical mode, and the second tactical mode is different from the first tactical mode.

In some embodiments, the first tactical mode corresponds to a first assisting control, and the first assisting control is configured to trigger displaying of the assisting battle animation. The display module 1510 is further configured to switch displaying from the first assisting control to a second assisting control corresponding to the second tactical mode.

In some embodiments, the plurality of associated virtual objects separately correspond to different offense-defense capabilities.

The apparatus further includes:
an obtaining module 1530, configured to obtain a tactical policy corresponding to the first tactical mode, where the tactical policy includes a plurality of positions and reference battle actions separately corresponding to the plurality of positions, and the plurality of positions separately correspond to offense-defense conditions;
a determining module 1540, configured to determine, in response to the offense-defense capability corresponding to an i^{th} associated virtual object among the plurality of associated virtual objects satisfying the offense-defense condition corresponding to an n^{th} position among the plurality of positions, an association relationship between the reference battle action corresponding to the n^{th} position and the i^{th} associated virtual object, where i and n are positive integers; and
a generation module 1550, configured to generate, based on the association relationships between the plurality of associated virtual objects and the plurality of reference battle actions, a tactical behavior tree corresponding to the first tactical mode.

In some embodiments, the obtaining module 1530 is configured to obtain action behavior trees separately corresponding to the plurality of associated virtual objects, where the action behavior tree corresponding to the associated virtual object includes a plurality of battle action branches of the associated virtual object in a virtual battle process, and the plurality of battle action branches are marked with different weight values.

The determining module 1540 is configured to determine, according to an action type corresponding to the battle action branch having the highest weight value among the plurality of battle action branches, the offense-defense capability corresponding to the associated virtual object.

In some embodiments, the obtaining module 1530 is configured to: obtain, in response to receiving the selection operation on the first tactical mode, a tactical behavior tree corresponding to the first tactical mode, where the tactical behavior tree includes association relationships between the plurality of associated virtual objects and the plurality of reference battle actions; obtain action behavior trees separately corresponding to the plurality of associated virtual objects, where the action behavior tree corresponding to the associated virtual object includes a plurality of battle action branches of the associated virtual object in a virtual battle process; and obtain, based on the association relationship between an m^{th} associated virtual object and the reference battle action corresponding to a p^{th} position in the tactical behavior tree, a target battle action branch in the action behavior tree corresponding to an m^{th} associated virtual object, where the target battle action branch corresponds to the reference battle action corresponding to the p^{th} position, and m and p are positive integers.

The display module 1510 is further configured to display, based on the target battle action branch, that the m^{th} associated virtual object is located at the p^{th} position, and display an animation in which the m^{th} associated virtual object executes a battle action corresponding to the target battle action branch.

In some embodiments, the receiving module 1520 is further configured to continuously receive selection operations on the first tactical mode and a third tactical mode, where the third tactical mode corresponds to a target battle condition.

The display module 1510 is further configured to display, in response to the selection operation and in response to a battle situation satisfying the target battle condition in the process of performing a virtual battle based on the first tactical mode, automatic switching of the plurality of associated virtual objects from the first tactical mode to the third tactical mode to perform a virtual battle with the battle virtual object.

In conclusion, according to the virtual object interaction apparatus provided in this embodiment of this application, in a process in which a first virtual object and a plurality of associated virtual objects perform a combined battle with a battle virtual object, if a selection operation on a first tactical mode is received, the plurality of associated virtual objects may position according to a distribution rule corresponding to the first tactical mode, and execute reference battle actions corresponding to the first tactical mode. The associated virtual objects position and act according to a tactical mode selected by a player, so that a behavior mode of an associated object can meet a current tactical requirement of the player, thereby improving cooperation between the player and a plurality of virtual objects. In addition, in a battle process, when a battle assisting operation is received, a target associated object in the plurality of associated virtual objects stops executing the reference battle action and performs location adjustment, so as to assist, at a latest location after adjustment, the first virtual object in performing a battle. To be specific, the target associated object can perform real-time adjustment according to the battle assisting operation of the player, to cooperate with a current operation policy of the player, to provide better assistance for the player, thereby further improving the cooperation between the player and the plurality of virtual objects. In addition, an associated virtual role can be adjusted in cooperation with a player operation by using a simple battle assisting operation, to avoid complex operation adjustment performed by the player on the first virtual object to apply to the associated virtual object, thereby improving human-computer interaction efficiency and reducing overheads of computer operation resources.

The virtual object interaction apparatus provided in the foregoing embodiment is illustrated only with an example of division of the foregoing function modules. In practical applications, the foregoing functions may be allocated to and completed by different function modules according to requirements. To be specific, the internal structure of the apparatus is divided into different function modules to complete all or some of the functions described above. In addition, the virtual object interaction apparatus provided in the foregoing embodiment and the embodiment of the virtual object interaction method belong to the same concept. For a specific implementation process, refer to the method embodiments. Details are not described herein again.

FIG. 17 shows a structural block diagram of a terminal 1700 according to an exemplary embodiment of this application. The terminal 1700 may be: a smartphone, a tablet computer, a moving picture experts group audio layer III (MP3) player, or a moving picture experts group audio layer IV (MP4) player, a laptop computer, or a desktop computer. The terminal 1700 may also be referred to by another name such as user equipment, a portable terminal, a laptop terminal, or a desktop terminal.

Generally, the terminal 1700 includes: a processor 1701 and a memory 1702.

The processor 1701 may include one or more processing cores, for example, a 4-core processor or an 8-core processor. The processor 1701 may be implemented in at least one hardware form of a digital signal processor (DSP), a field-programmable gate array (FPGA), and a programmable logic array (PLA). The processor 1701 may alternatively include a main processor and a coprocessor. The main processor is configured to process data in a wake-up state, also referred to as a central processing unit (CPU). The coprocessor is a low-power processor configured to process data in a standby state. In some embodiments, the processor 1701 may be integrated with a graphics processing unit (GPU). The GPU is configured to render and draw content that needs to be displayed on a display screen. In some embodiments, the processor 1701 may further include an artificial intelligence (AI) processor. The AI processor is configured to process computing operations related to machine learning.

The memory 1702 may include one or more computer-readable storage media. The computer-readable storage medium may be non-transient. The memory 1702 may further include a high-speed random access memory and a nonvolatile memory, for example, one or more disk storage devices or flash storage devices. In some embodiments, the non-transitory computer-readable storage medium in the memory 1702 is configured to store at least one instruction. The at least one instruction is executed by the processor 1701 to perform the control method based on a virtual battle provided in the method embodiment in this application.

In some embodiments, the terminal 1700 further includes another component. A person skilled in the art may understand that the structure shown in FIG. 17 does not constitute a limitation on the terminal 1700. The terminal may include more or fewer components than those shown in the figure, or some merged components, or different component arrangements.

In some embodiments, the computer-readable storage medium may include a read only memory (ROM), a random access memory (RAM), a solid state drive (SSD), an optical disc, and the like. The RAM may include a resistance random access memory (ReRAM) and a dynamic random access memory (DRAM). The sequence numbers of the foregoing embodiments of this application are merely for description purposes but do not imply the preference among the embodiments.

A person of ordinary skill in the art may understand that all or some of the operations of the foregoing embodiments may be implemented by hardware, or may be implemented by a program instructing relevant hardware. The program may be stored in a non-transitory computer-readable storage medium. The storage medium may be a read-only memory, a magnetic disk, an optical disc, or the like.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely alternative embodiments of this application, but are not intended to limit this application. Any modification, equivalent replacement, or improvement made within the spirit and principle of this application shall fall within the protection scope of this application.

What is claimed is:

1. A virtual object interaction method performed by a computer device, the method comprising:
displaying a first virtual object, a plurality of associated virtual objects, and a battle virtual object in a virtual scene, the first virtual object being a virtual object controlled by a user of the computer device, and the plurality of associated virtual objects being configured for cooperating with the first virtual object to perform a virtual battle with the battle virtual object;
in response to receiving a selection operation on a first tactical mode by the user of the computer device, displaying a first tactical layout result corresponding to the first tactical mode; and
in response to receiving an object assisting operation in a process of performing a virtual battle based on the first tactical mode, displaying an assisting battle animation in which a target associated object in the plurality of associated virtual objects stops executing the reference battle action at a first location, moves from the first location to a second location, and assists, at the second location, the first virtual object to perform a virtual battle with the battle virtual object.

2. The method according to claim 1, wherein the displaying the assisting battle animation comprises:
displaying a first assisting control corresponding to the first tactical mode when the first virtual object satisfies an assisting condition in the process of performing a virtual battle based on the first tactical mode; and
displaying the assisting battle animation in response to receiving a trigger operation on the first assisting control.

3. The method according to claim 2, wherein the displaying the assisting battle animation in response to receiving the trigger operation on the first assisting control comprises:
in response to receiving the trigger operation on the first assisting control, obtaining offense-defense capabilities corresponding to the plurality of associated virtual objects in the virtual scene; and
in response to the offense-defense capability of the target associated object, displaying an animation in which the target associated object stops executing the reference battle action and moves from the first location to the second location to execute a first assisting action.

4. The method according to claim 2, wherein the displaying the assisting battle animation in response to receiving the trigger operation on the first assisting control comprises:
displaying an associated object list in response to receiving the trigger operation on the first assisting control, the associated object list comprising object identifiers separately corresponding to the plurality of associated virtual objects; and
displaying, in response to receiving a trigger operation on the object identifier corresponding to the target associated object, the assisting battle animation corresponding to the target associated object.

5. The method according to claim 1, wherein the method further comprises:
in response to receiving a tactical switching operation, switching the plurality of associated virtual objects from the first tactical layout result to a second tactical layout result.

6. The method according to claim 1, wherein the plurality of associated virtual objects separately corresponding to different offense-defense capabilities; and the method further comprises:
obtaining a tactical policy corresponding to the first tactical mode, the tactical policy comprising a plurality of positions and reference battle actions separately corresponding to the plurality of positions, and the plurality of positions separately corresponding to offense-defense conditions;
determining, in response to the offense-defense capability corresponding to an i^{th} associated virtual object among the plurality of associated virtual objects satisfying the offense-defense condition corresponding to an n^{th} position among the plurality of positions, an association relationship between the reference battle action corresponding to the n^{th} position and the i^{th} associated virtual object, i and n being positive integers; and
generating, based on the association relationships between the plurality of associated virtual objects and the plurality of reference battle actions, a tactical behavior tree corresponding to the first tactical mode.

7. The method according to claim 1, further comprising:
continuously receiving selection operations on the first tactical mode and a third tactical mode, the third tactical mode corresponding to a target battle condition; and
displaying, in response to a battle situation satisfying the target battle condition in the process of performing a virtual battle based on the first tactical mode, automatic switching of the plurality of associated virtual objects from the first tactical mode to the third tactical mode to perform a virtual battle with the battle virtual object.

8. The method according to claim 1, wherein the first tactical layout result is configured for indicating that the plurality of associated virtual objects position in a distribution rule of the first tactical mode and execute reference battle actions corresponding to the first tactical mode.

9. A computer device, comprising a processor and a memory, the memory having at least one program stored therein, and the at least one program, when loaded and executed by the processor, causing the computer device to implement a virtual object interaction method including:
displaying a first virtual object, a plurality of associated virtual objects, and a battle virtual object in a virtual scene, the first virtual object being a virtual object controlled by a user of the computer device, and the plurality of associated virtual objects being configured for cooperating with the first virtual object to perform a virtual battle with the battle virtual object;
in response to receiving a selection operation on a first tactical mode by the user of the computer device, displaying a first tactical layout result corresponding to the first tactical mode; and
in response to receiving an object assisting operation in a process of performing a virtual battle based on the first tactical mode, displaying an assisting battle animation in which a target associated object in the plurality of associated virtual objects stops executing the reference battle action at a first location, moves from the first location to a second location, and assists, at the second location, the first virtual object to perform a virtual battle with the battle virtual object.

10. The computer according to claim 9, wherein the displaying the assisting battle animation comprises:
displaying a first assisting control corresponding to the first tactical mode when the first virtual object satisfies an assisting condition in the process of performing a virtual battle based on the first tactical mode; and
displaying the assisting battle animation in response to receiving a trigger operation on the first assisting control.

11. The computer according to claim 10, wherein the displaying the assisting battle animation in response to receiving the trigger operation on the first assisting control comprises:
in response to receiving the trigger operation on the first assisting control, obtaining offense-defense capabilities corresponding to the plurality of associated virtual objects in the virtual scene; and
in response to the offense-defense capability of the target associated object, displaying an animation in which the target associated object stops executing the reference battle action and moves from the first location to the second location to execute a first assisting action.

12. The computer according to claim 10, wherein the displaying the assisting battle animation in response to receiving the trigger operation on the first assisting control comprises:
displaying an associated object list in response to receiving the trigger operation on the first assisting control, the associated object list comprising object identifiers separately corresponding to the plurality of associated virtual objects; and
displaying, in response to receiving a trigger operation on the object identifier corresponding to the target associated object, the assisting battle animation corresponding to the target associated object.

13. The computer according to claim 9, wherein the method further comprises:
in response to receiving a tactical switching operation, switching the plurality of associated virtual objects from the first tactical layout result to a second tactical layout result.

14. The computer according to claim 9, wherein the plurality of associated virtual objects separately corresponding to different offense-defense capabilities; and the method further comprises:
obtaining a tactical policy corresponding to the first tactical mode, the tactical policy comprising a plurality of positions and reference battle actions separately corresponding to the plurality of positions, and the plurality of positions separately corresponding to offense-defense conditions;
determining, in response to the offense-defense capability corresponding to an i^{th} associated virtual object among the plurality of associated virtual objects satisfying the offense-defense condition corresponding to an n^{th} position among the plurality of positions, an association relationship between the reference battle action corresponding to the n^{th} position and the i^{th} associated virtual object, i and n being positive integers; and
generating, based on the association relationships between the plurality of associated virtual objects and the plurality of reference battle actions, a tactical behavior tree corresponding to the first tactical mode.

15. The computer according to claim 9, wherein the method further comprises:
continuously receiving selection operations on the first tactical mode and a third tactical mode, the third tactical mode corresponding to a target battle condition; and
displaying, in response to a battle situation satisfying the target battle condition in the process of performing a virtual battle based on the first tactical mode, automatic switching of the plurality of associated virtual objects from the first tactical mode to the third tactical mode to perform a virtual battle with the battle virtual object.

16. The computer according to claim 9, wherein the first tactical layout result is configured for indicating that the plurality of associated virtual objects position in a distribution rule of the first tactical mode and execute reference battle actions corresponding to the first tactical mode.

17. A non-transitory computer-readable storage medium, having at least one program stored therein, the at least one program, when loaded and executed by a processor of a computer device, causing the computer device to implement a virtual object interaction method including:
displaying a first virtual object, a plurality of associated virtual objects, and a battle virtual object in a virtual scene, the first virtual object being a virtual object controlled by a user of the computer device, and the plurality of associated virtual objects being configured for cooperating with the first virtual object to perform a virtual battle with the battle virtual object;
in response to receiving a selection operation on a first tactical mode by the user of the computer device, displaying a first tactical layout result corresponding to the first tactical mode; and
in response to receiving an object assisting operation in a process of performing a virtual battle based on the first tactical mode, displaying an assisting battle animation in which a target associated object in the plurality of associated virtual objects stops executing the reference battle action at a first location, moves from the first location to a second location, and assists, at the second location, the first virtual object to perform a virtual battle with the battle virtual object.

18. The non-transitory computer-readable storage medium according to claim 17, wherein the displaying the assisting battle animation comprises:
displaying a first assisting control corresponding to the first tactical mode when the first virtual object satisfies an assisting condition in the process of performing a virtual battle based on the first tactical mode; and
displaying the assisting battle animation in response to receiving a trigger operation on the first assisting control.

19. The non-transitory computer-readable storage medium according to claim 17, wherein the method further comprises:
continuously receiving selection operations on the first tactical mode and a third tactical mode, the third tactical mode corresponding to a target battle condition; and
displaying, in response to a battle situation satisfying the target battle condition in the process of performing a virtual battle based on the first tactical mode, automatic switching of the plurality of associated virtual objects from the first tactical mode to the third tactical mode to perform a virtual battle with the battle virtual object.

20. The non-transitory computer-readable storage medium according to claim 17, wherein the first tactical layout result is configured for indicating that the plurality of associated virtual objects position in a distribution rule of the first tactical mode and execute reference battle actions corresponding to the first tactical mode.
